(19) United States
(12) Patent Application Publication
(10) Pub. No.: US 2012/0143683 A1
(43) Pub. Date: Jun. 7, 2012

(54) Real-Time Sentiment Index

(75) Inventors: Frank M. Hertz, Ipswich, MA (US); Robert S. Roesler, Ipswich, MA (US); Scott S. Cohen, Needham, MA (US)

(73) Assignee: FANTAB CORPORATION, Ipswich, MA (US)

(21) Appl. No.: 12/961,162

(22) Filed: Dec. 6, 2010

(51) Int. Cl. G06F 17/30

(52) U.S. Cl. 705/14.49; 707/741; 707/E17.002

(57) ABSTRACT

Embodiments of a method are disclosed that comprise receiving, over a communications network, user-initiated quantitative sentiment ratings regarding an entity and calculating a real-time sentiment index for the entity using the received sentiment ratings. Embodiments of apparatus are also disclosed that comprise a plurality of computing devices each including an interface configured for the input of user-initiated quantitative sentiment ratings and a server which is configured to (i) receive sentiment ratings from the plurality of computing devices, (ii) determine a first subset of the received sentiment ratings that relate to a first entity, and (iii) calculate a first real-time sentiment index for the first entity using sentiment ratings from the first subset.

### BACKGROUND

The present disclosure relates, generally, to systems and methods for generating a real-time sentiment index and, more particularly, to systems and methods that calculate a real-time sentiment index for an entity using user-initiated quantitative sentiment ratings regarding the entity. A sentiment index may be a value that indicates an opinion, an attitude, or a feeling regarding an entity and may be based upon the viewpoints of a single individual, a group, a community, or the general public, for example. By way of example, a sentiment index may be used to track perceptions regarding a business entity, a brand, or a product. As another example, a sentiment index may be used to track perceptions regarding a politician or a political organization.

### SUMMARY

According to one aspect, a method may comprise receiving, over a communications network, user-initiated quantitative sentiment ratings regarding an entity and calculating a real-time sentiment index for the entity using the received sentiment ratings. In some embodiments, the entity may be a sports team or an individual athlete. In other embodiments, the entity may be user-defined. Calculating the real-time sentiment index may comprise updating a perpetual sentiment index. Calculating the real-time sentiment index may comprise recalculating the real-time sentiment index at least once every minute when new sentiment ratings have been received.

In some embodiments, receiving user-initiated quantitative sentiment ratings may comprise receiving user-initiated quantitative sentiment ratings from a plurality of users. In such embodiments, calculating the real-time sentiment index may comprise calculating a real-time mean or a real-time median of the sentiment ratings received from the plurality of users. The plurality of users may include all users that are providing sentiment ratings regarding the entity. In other embodiments, the plurality of users may include a user-defined subset of all users that are providing sentiment ratings regarding the entity.

The method may further comprise transmitting the real-time sentiment index over the communications network for display to a user. The method may also further comprise storing the received sentiment ratings in a database of historic sentiment ratings. In such embodiments, the method may further comprise calculating historic values of the real-time sentiment index over a past time period using the historic sentiment ratings. The method may also further comprise transmitting the historic values of the real-time sentiment index over the communications network for display to a user.

In some embodiments, the method may further comprise transmitting one or more news items regarding the entity that were generated during the past time period over the communications network for display along with the historic values of the real-time sentiment index. In other embodiments, the method may further comprise receiving one or more user comments regarding the entity, the one or more user comments being generated contemporaneously with the user-initiated quantitative sentiment ratings. The method may also further comprise transmitting one or more user comments regarding the entity that were generated during the past time period over the communications network for display along with the historic values of the real-time sentiment index. In still other embodiments, the method may further comprise transmitting the historic sentiment ratings that were generated by a particular user during the past time period over the communications network for display along with the historic values of the real-time sentiment index.

In other embodiments, the method may further comprise transmitting a comparison of the real-time quantitative sentiment index for the entity with a real-time sentiment index for a competitive entity over the communications network for display to a user. The method may also further comprise transmitting an advertisement over the communications network for display to a user, the advertisement having content related to the entity for which sentiment ratings are received.

According to another aspect, one or more non-transitory, machine-readable media may comprise a plurality of instructions that, when executed, result in a processor receiving, over a communications network, user-initiated quantitative sentiment ratings regarding an entity and calculating a real-time sentiment index for the entity using the received sentiment ratings. In some embodiments, the entity may be a sports team or an individual athlete. In other embodiments, the entity may be user-defined. Calculating the real-time sentiment index may comprise updating a perpetual sentiment index. Calculating the real-time sentiment index may comprise recalculating the real-time sentiment index at least once every minute when new sentiment ratings have been received.

In some embodiments, receiving user-initiated quantitative sentiment ratings may comprise receiving user-initiated quantitative sentiment ratings from a plurality of users. In such embodiments, calculating the real-time sentiment index may comprise calculating a real-time mean or a real-time median of the sentiment ratings received from the plurality of users. The plurality of users may include all users that are providing sentiment ratings regarding the entity. In other embodiments, the plurality of users may include a user-defined subset of all users that are providing sentiment ratings regarding the entity.

The plurality of instructions, when executed, may further result in the processor transmitting the real-time sentiment index over the communications network for display to a user. The plurality of instructions, when executed, may also further result in the processor storing the received sentiment ratings in a database of historic sentiment ratings. In such embodiments, the plurality of instructions, when executed, may further result in the processor calculating historic values of the real-time sentiment index over a past time period using the historic sentiment ratings. The plurality of instructions, when executed, may also further result in the processor transmitting the historic values of the real-time sentiment index over the communications network for display to a user.

In some embodiments, the plurality of instructions, when executed, may further result in the processor transmitting one or more news items regarding the entity that were generated during the past time period over the communications network for display along with the historic values of the real-time sentiment index. In other embodiments, the plurality of instructions, when executed, may further result in the processor receiving one or more user comments regarding the entity, the one or more user comments being generated contemporaneously with the user-initiated quantitative sentiment ratings. The plurality of instructions, when executed, may also further result in the processor transmitting one or more user comments regarding the entity that were generated during the past time period over the communications network for display along with the historic values of the real-time sentiment index. In still other embodiments, the plurality of instructions, when executed, may also further result in the processor transmitting the historic sentiment ratings that were generated by a particular user during the past time period over the communications network for display along with the historic values of the real-time sentiment index.

In other embodiments, the plurality of instructions, when executed, may further result in the processor transmitting a comparison of the real-time quantitative sentiment index for the entity with a real-time sentiment index for a competitive entity over the communications network for display to a user. The plurality of instructions, when executed, may also further result in the processor transmitting an advertisement over the communications network for display to a user, the advertisement having content related to the entity for which sentiment ratings are received.

According to yet another aspect, an apparatus may comprise a plurality of computing devices each including an interface configured for the input of user-initiated quantitative sentiment ratings and a server which is configured to (i) receive sentiment ratings from the plurality of computing devices, (ii) determine a first subset of the received sentiment ratings that relate to a first entity, and (iii) calculate a first real-time sentiment index for the first entity using sentiment ratings from the first subset.

In some embodiments, the server may be configured to recalculate the first real-time sentiment index at least once every minute when new sentiment ratings that relate to the first entity have been received. The interface of each of the plurality of computing devices may comprise a graphical slider that a user may set to a number indicating the user's present sentiment toward an entity. Each of the plurality of computing devices may comprise a dedicated application that controls the interface and transmits input sentiment ratings to the server. In other embodiments, the server may be configured to receive sentiment ratings from the plurality of computing devices via at least one of electronic mail and SMS messages.

The server may be further configured to transmit the first real-time sentiment index to the plurality of computing devices, and the interface of each of the plurality of computing devices may be further configured to display the first real-time sentiment index. In some embodiments, the server may be further configured to store the received sentiment ratings in a database of historic sentiment ratings. In such embodiments, the server may be further configured to calculate historic values of the first real-time sentiment index over a past time period using historic sentiment ratings from the first subset. The server may be further configured to transmit the historic values of the first real-time sentiment index to the plurality of computing devices, and the interface of each of the plurality of computing devices may be further configured to display the historic values of first real-time sentiment index. The interface of each of the plurality of computing devices may be configured to display a graph of the historic values of first real-time sentiment index over the past time period.

In some embodiments, the server may be further configured to transmit one or more news items relating to the first entity that were generated during the past time period to the plurality of computing devices, and the interface of each of the plurality of computing devices may be further configured to display the one or more news items along with historic values of first real-time sentiment index. In other embodiments, the interface of each of the plurality of computing devices may be further configured for the input of user comments contemporaneously with the input of user-initiated quantitative sentiment ratings. In such embodiments, the server may be further configured to transmit one or more user comments relating to the first entity that were input during the past time period to the plurality of computing devices, and the interface of each of the plurality of computing devices may be further configured to display the one or more user comments along with historic values of first real-time sentiment index. The server may be further configured to transmit an advertisement having content related to the first entity to each of the plurality of computing devices that transmits sentiment ratings relating to the first entity.

In still other embodiments, the server may be further configured to (i) determine a second subset of the received sentiment ratings that relate to a second entity and (ii) calculate a second real-time sentiment index for the second entity using the second subset of the received sentiment ratings. The first and second entities may each be sports teams or individual athletes. In other embodiments, the first and second entities may each belong to a user-defined category.

The server may be further configured to transmit a comparison of the first real-time sentiment index and the second real-time sentiment index to the plurality of computing devices, and the interface of each of the plurality of computing devices may be further configured to display the comparison. In some embodiments, the server may be further configured to store the received sentiment ratings in a database of historic sentiment ratings. In such embodiments, the server is further configured to calculate historic values of the first real-time sentiment index over a past time period using historic sentiment ratings from the first subset and calculate historic values of the second real-time sentiment index over the past time period using historic sentiment ratings from the second subset. The server may be further configured to transmit a comparison of the historic values of the first real-time sentiment index and the historic values of the first real-time sentiment index to the plurality of computing devices, and the interface of each of the plurality of computing devices may be further configured to display the comparison. The comparison may comprise a graph illustrating the historic values of the first real-time sentiment index and the historic values of the first real-time sentiment index over the past time period.

### BRIEF DESCRIPTION OF THE DRAWINGS

The systems, devices, and methods described herein are illustrated by way of example, and not by way of limitation, in the accompanying figures. For simplicity and clarity of illustration, elements illustrated in the figures are not necessarily drawn to scale. For example, the dimensions of some elements may be exaggerated relative to other elements for clarity. In the following figures:

FIG. 1 is a simplified step diagram of one embodiment of a system for generating a real-time sentiment index;

FIG. 2 is a simplified flow diagram of one embodiment of a method of generating a real-time sentiment index, which may be performed by the system of FIG. 1; and

FIG. 3 is a representation of one embodiment of an interface that may be used to input user-initiated quantitative sentiment ratings and to display a real-time sentiment index.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details, such as the types and interrelationships of system components, may be set forth in order to provide a more thorough understanding of the present disclosure. It will be appreciated, however, by one skilled in the art that embodiments of the disclosure may be practiced without such specific details. In other instances, control structures, gate level circuits, and full software instruction sequences may not have been shown in detail in order not to obscure the disclosure. Those of ordinary skill in the art, with the included descriptions, will be able to implement appropriate functionality without undue experimentation.

References in the specification to “one embodiment,” “an embodiment,” “an illustrative embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, software, or any combination thereof Embodiments of the disclosure implemented in a computer network may include one or more wired communications links between components and/or one or more wireless communications links between components. Embodiments of the invention may also be implemented as instructions stored on one or more non-transitory, machine-readable media, which may be read and executed by one or more processors. A non-transitory, machine-readable medium may include any tangible mechanism for storing or transmitting information in a form readable by a machine (e.g., a computing device). For example, a non-transitory, machine-readable medium may include read only memory (ROM), random access memory (RAM), magnetic disk storage media, optical storage media, flash memory devices, and other tangible media.

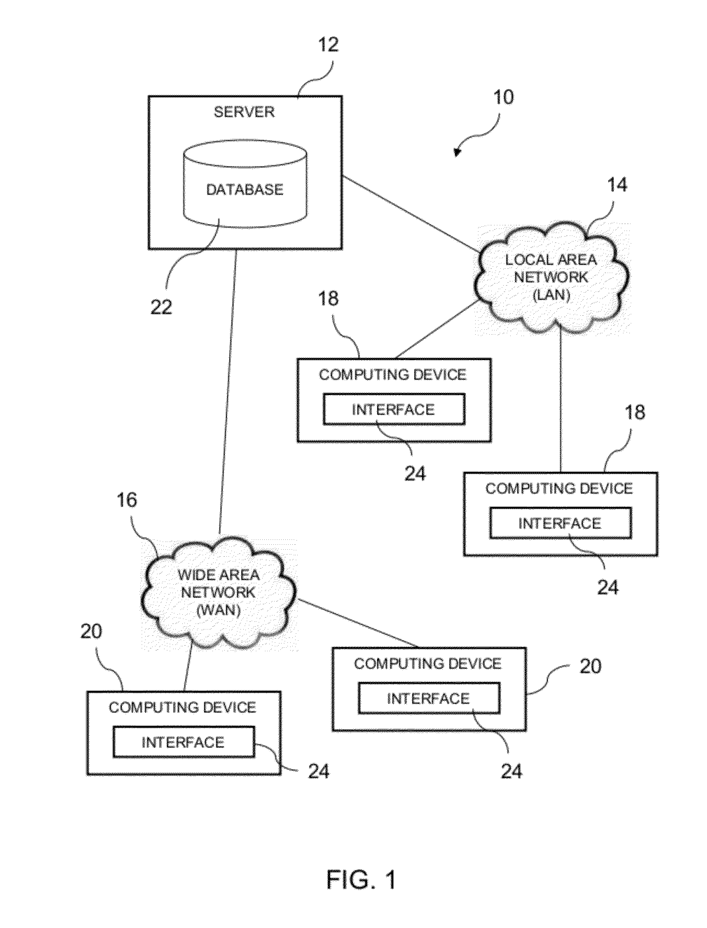

Referring now to FIG. 1, a system 10 for generating a real-time sentiment index includes a server 12, a number of communications networks 14, 16, and a number of computing devices 18, 20 that are each communicatively coupled to the server 12 via at least one of the communications networks 14, 16. While the illustrative embodiment of the system 10 is shown in FIG. 1 as including a plurality of communications networks 14, 16 that are each communicatively coupled to a plurality of computing devices 18, 20, it is contemplated that the system 10 may include any number of communications networks and computing devices (including a single computing device communicatively coupled to the server via a single communications network in some embodiments).

The server 12 functions as a central hub of the system 10 in the illustrative embodiment. As will be explained in more detail below, the server 12 may receive information from the computing devices 18, 20 (via one or more of the communications networks 14, 16), may store and/or process information, and may transmit information to the computing devices 18, 20 (also via one or more of the communications networks 14, 16). The server 12 may be embodied as any type of electronic device capable of performing the functions described herein, such as a computer. In the illustrative embodiment, the server 12 includes a memory, or other machine-readable media, storing a database 22. The server 12 may access the database 22 to store information received from the computing devices 18, 20, or other information, for later retrieval. Although not shown in FIG. 1 for clarity of the description, the server 12 may include any number of components, sub-components, and devices commonly found in a computer and/or computing device. For instance, the server 12 may include communication circuitry that enables the server 12 to transmit and to receive information over the communications networks 14, 16.

The system 10 includes one or more communications networks 14, 16. As shown in FIG. 1, the system 10 illustratively includes a local area network (LAN) 14 that communicatively couples the computing devices 18 to the server 12 and a wide area network (WAN) 16 that communicatively couples the computing devices 20 to the server 12. Additional computing devices (not shown) may communicate with the server 12 over either or both of the LAN 14 and the WAN 16. Both the LAN 14 and the WAN 16 may be embodied as, or otherwise include, any number of wired and/or wireless communications networks. Furthermore, both the LAN 14 and the WAN 16 may include any number of additional devices to facilitate communication between the server 12 and the computing devices 18, 20, such as routers, switches, intervening computers, and the like.

The WAN 16 is a communications network which covers a relatively large geographic area, as compared to the LAN 14. In some embodiments, the WAN 16 may include a wired, IP-based network (e.g., the Internet). Alternatively or additionally, the WAN 16 may include a wireless wide-area network (WWAN) that employs a cellular radio network to provide wireless communications, possibly on a citywide or even nationwide basis. Illustrative embodiments of a WWAN include telecommunications networks configured according to the GSM (Groupe Spécial Mobile), 3G, and 4G standards.

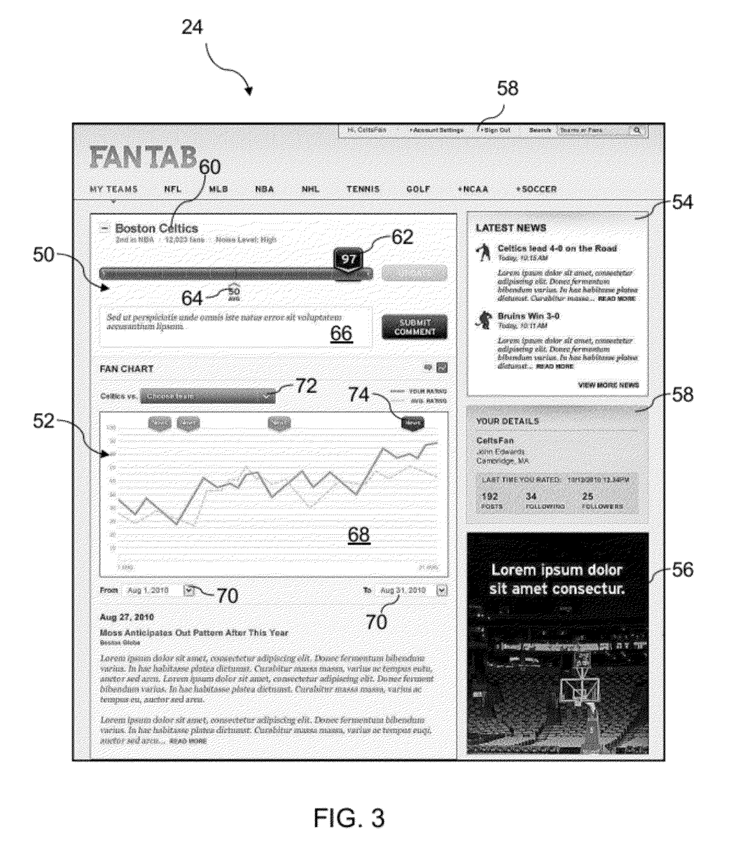

The system 10 also includes one or more computing devices 18, 20. The computing devices 18, 20 may be embodied as any type of electronic devices separate from the server 12. For example, the computing devices 18, 20 may be embodied as one or more personal computers, workstations, laptop computers, handheld computers, mobile internet devices, cellular phones, personal data assistants, telephony devices, network appliances, virtualization devices, storage controllers, or other computer-based devices. Each of the computing devices 18, 20 includes an interface 24 that may be used to input user-initiated quantitative sentiment ratings and to display a real-time sentiment index. One illustrative embodiment of the interface 24 will be further described below with reference to FIG. 3. Although not shown in FIG. 1 for clarity of the description, the computing devices 18, 20 may also include any number of components, sub-components, and devices commonly found in a computer and/or computing device. For instance, each of the computing devices 18, 20 may include communication circuitry that enables the computing device 18, 20 to transmit and to receive information over one or both of the LAN 14 and the WAN 16.

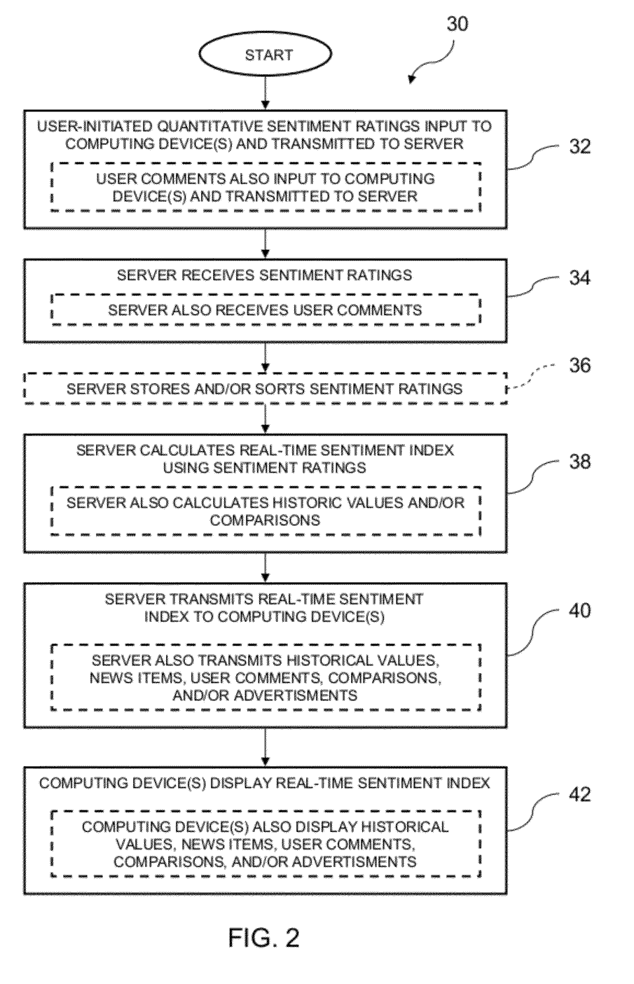

The system 10 may be configured to execute a method 30 for generating a real-time sentiment index, one embodiment of which is illustrated in FIG. 2. Various steps of the method 30 may be executed by, for example, the server 12 or one of the computing devices 18, 20. The method 30 may allow the generation of a real-time sentiment index for tracking opinions, attitudes, or feelings regarding any type of entity. In the illustrative embodiment, the system 10 and the method 30 are configured to generate a real-time sentiment index for a sports team or an individual athlete. Furthermore, the system 10 and the method 30 may be configured to generate a real-time sentiment index for each sports team in a professional league (e.g., the National Basketball Association), allowing a variety of comparisons between the sports teams' real-time sentiment indexes, as described in more detail below. It will be appreciated by those of skill in the art that the system 10 and the method 30 may also be configured to generate a real-time sentiment index for other types of entities, including, but not limited to, business entities, brands, products, politicians, political organizations, and others. It is also contemplated that some embodiments may allow for user customization of the system 10 and the method 30, such that a real-time sentiment index is generated for a user-defined entity.

Referring now to FIG. 2, the method 30 begins with step 32 in which user-initiated quantitative sentiment ratings are input (e.g., by a user) into the interface(s) 24 of one or more of the computing devices 18, 20. In the illustrative embodiment, the sentiment ratings take the form of a number that a user can set between a minimum and maximum value (e.g., between 0 and 100) to indicate the user's present opinion, attitude, or feeling regarding a sports team. Additionally, the sentiment ratings are user-initiated, meaning that the user can input a new, or modified, sentiment rating for the sports team using the interface 24 of their computing device 18, 20 whenever desired, without awaiting a query from the server 12.

The interface 24 of each computing device 18, 20 may take any form which allows for the input of user-initiated quantitative sentiment ratings. For instance, where the computing device 18, 20 includes a web-browser program (e.g., Internet Explorer, Mozilla Firefox, or the like), the interface 24 may be embodied as a webpage. One illustrative embodiment of an interface 24 having the form of a webpage is shown in FIG. 3, which will be explained in more detail below. Alternatively or additionally, where the computing device 18, 20 is a mobile device (e.g., an Apple iPhone, a Blackberry, or the like), the interface 24 may be part of a dedicated application that runs on the mobile device. Such a dedicated application may provide an interface 24 with similar content and functionality to a webpage, but optimized for the physical display of the mobile device. In other embodiments, however, the interface 24 may be text-based and need not include graphics. For instance, the system 10 may be configured so that a user may utilize their computing device 18, 20 to input a new, or modified, sentiment rating by sending electronic mail and/or an SMS message with appropriate content to a specified address.

In some embodiments, step 32 may also involve the input of other types of information into the interface(s) 24 of one or more of the computing devices 18, 20 contemporaneously with the input of the user-initiated quantitative sentiment ratings. For instance, the interface 24 may be configured for the input of user comments along with the sentiment ratings. In such embodiments, the user is able to provide text, if desired, explaining their reason or motivation for modifying their sentiment rating for the entity. Whenever new sentiment ratings (and/or additional information, such as user comments) are input to the interface 24 of a computing device 18, 20, or at periodic intervals, the computing device 18, 20 will transmit the new information to the server 12 via one of the LAN 14 and the WAN 16.

After step 32, the method 30 proceeds to step 34 in which the server 12 receives the sentiment ratings from one or more of the computing devices 18, 20 over one or both of the LAN 14 and the WAN 16. In embodiments where additional information (e.g., user comments) is generated in step 32, step 34 may also involve the server 12 receiving the additional information from one or more of the computing devices 18, 20. The server 12 may receive sentiment ratings from any number of computing devices 18, 20 in step 34. In the illustrative embodiment, the server 12 may receive sentiment ratings (and, optionally, additional information) from a plurality of computing devices 18, 20 representing the sentiment ratings of a plurality of users of the system 10.

After step 34, the method 30 optionally proceeds to step 36 in which the server 12 may perform some form of initial processing on the sentiment ratings (and any additional information) received in step 34. In the illustrative embodiment, for example, the server 12 stores all of the received sentiment ratings and additional information in the database 22. Thus, the database 22 functions as a repository of historic sentiment ratings received from all users for all sports teams. These historic sentiment ratings may be later retrieved by the server 12 for analysis or other processing. In some embodiments, the server 12 may receive sentiment ratings for several distinct entities in step 34. In such embodiments, the server 12 may perform some form of sorting, or labeling, of the received sentiment ratings in step 36. By way of example, in the illustrative embodiment, the server 12 may receive sentiment ratings for numerous sports teams from one or more computing devices 18, 20. In step 36, the server 12 may sort or label the received sentiment ratings according to the concerned sports team (and, further, according to the appropriate sport or league). Such sorting, or labeling, allows the server 12 to determine which subset of the received sentiment ratings relate to a particular sports team (and, thereby, which subset of the received sentiment ratings should be used in calculating a real-time sentiment index).

After step 36 (or after step 34 in some embodiments), the method 30 proceeds to step 38 in which the server 12 calculates a real-time sentiment index for an entity using the received sentiment ratings. It is contemplated that the server 12 may calculate the real-time sentiment index using many different mathematical approaches. For instance, in some embodiments, the real-time sentiment index for an entity may be the mean or median of set consisting of the last sentiment rating for that entity provided by each user. In other embodiments, the real-time sentiment index for an entity may be the mean or median of set consisting of all sentiment ratings for that entity provided over a recent time period (e.g., the last hour, day, or week). In still other embodiments, the real-time sentiment index may involve some form of weighted average of a set of sentiment ratings (e.g., sentiment ratings from certain users may be entitled to more or less weight, depending on factors such as notoriety or frequency of use of the system 10).

In the illustrative embodiment, the real-time sentiment index for each sports team is a perpetual sentiment index, the value of which is continuously updated in real-time as new sentiment ratings are received by the server 12. More specifically, the server 12 recalculates the real-time sentiment index for each sports team at least once every minute in step 38. It is also contemplated that the real-time sentiment index for each sports team may be updated more or less frequently, in other embodiments. The illustrative embodiment of system 10 may also allow a user to obtain a customized real-time sentiment index. For instance, while the real-time sentiment index for a sports team is normally calculated using the sentiment ratings of all users that are providing sentiment ratings regarding that sports team, a user may also choose to see a real-time sentiment index for the sports team calculated using only the sentiment ratings of some user-defined subset of all users (e.g., a user may choose to view a real-time sentiment index based only on the sentiment ratings of their friends).

In some embodiments, step 38 may also involve the server 12 performing other calculations relating to a real-time sentiment index. For instance, in embodiments of the system 10 which maintain a database 22 of historic sentiment ratings, step 38 may also involve the server 12 calculating historic values of a real-time sentiment index over a past time period. For instance, the server may calculate historic values of the real-time sentiment index for a particular sports team over the past month. It will be appreciated that historic values of the real-time sentiment index over other past time periods (e.g., the last hour, day, or year) might also be calculated by the server 12. Additionally, step 38 may also involve the server 12 performing a comparison of the real-time sentiment indexes of competitive entities. In the illustrative embodiment, for instance, the server 12 may compare the real-time sentiment indexes (and/or historic values of those real-time sentiment indexes) for two sports teams in the same division, league, or sport. It is also contemplated that the server 12 may perform a comparison between the historic sentiment ratings regarding an entity that were generated by a particular user or group of users and the historic values of the real-time sentiment index for that entity.

After step 38, the method 30 proceeds to step 40 in which the server 12 transmits the real-time sentiment index to one or more of the computing devices 18, 20 over one or both of the LAN 14 and the WAN 16. In the illustrative embodiment, the server 12 will transmit all real-time sentiment indexes calculated in step 38 to each of the computing devices 18, 20 of the system 10 in step 40. Thus, each computing device 18, 20 may access the real-time sentiment index of any sports team tracked by the system 10. The server 12 may also transmit any historic values of the real-time sentiment indexes and any comparisons of the real-time sentiment indexes calculated in step 38 to one or more of the computing devices 18, 20 in step 40.

In some embodiments, step 40 may also involve the server 12 transmitting additional information relating to a real-time sentiment index. For instance, when transmitting the real-time sentiment index for a sports team to a computing device 18, 20, the server 12 may also transmit one or more news items regarding that sports team to the computing device 18, 20. Each news item may be illustratively embodied as the text of an article or other online posting, an image, a video, and/or a hyperlink. In embodiments in which user comments regarding a sports team are received in step 34, the server 12 may transmit one or more such user comments along with the real-time sentiment index for the sports team in step 40. When the server 12 is transmitting historic values of a real-time sentiment index from a past time period, the news items and/or user comments that are transmitted to the computing devices 18, 20 may be limited to those that were generated during the same past time period. In some embodiments, the server 12 may also transmit an advertisement to a computing device 18, 20 with advertising content related to the sports team(s) for which the computing device 18, 20 provides sentiment ratings.

After step 40, the method 30 proceeds to step 42 in which the computing devices 18, 20 that receive the real-time sentiment index from the server 12 display the real-time sentiment index to a user via the interface 24. In embodiments where additional information is transmitted in step 40, step 42 may also involve the display of this additional information on the interface 24 along with the real-time sentiment index. Once again, the interface 24 of each computing device 18, 20 may take any form which allows for the display of the real-time sentiment index (and, possibly, any additional information). In some embodiments, the interface 24 may be embodied as a webpage (such as the webpage illustrated in FIG. 3) or the graphical interface of a dedicated application running on the computing device 18, 20. In other embodiments, however, the interface 24 may be text-based and need not include graphics (e.g., an electronic mail or SMS message program).

Although the steps of the method 30 have been described sequentially, it will be appreciated by those of skill in the art that many or all of these steps may occur simultaneously, or in parallel. For instance, the server 12 may be calculating a real-time sentiment index for one entity (step 38) while it is receiving sentiment ratings regarding another entity (step 34). As another example, the interface 24 of a computing device 18, 20 may simultaneously display information (step 42) while accepting user inputs (step 32). Furthermore, while various steps in the method 30 have been described as being performed by either the server 12 or one or more of the computing devices 18, 20 in the illustrative embodiment, it will be appreciated that, in other embodiments, those steps or similar steps may be performed by different components of the system 10.

Referring now to FIG. 3, one illustrative embodiment of an interface 24 having the form of a webpage is shown. The interface 24 includes a graphical input mechanism 50 and various graphical and textual display areas 52, 54, 56, 58. The sports team to which the information currently presented on the interface 24 relates is indicated by a legend 60. As shown in FIG. 3, the graphical input mechanism 50 is illustratively embodied as a graphical slider 50 that allows a user to visually adjust their sentiment rating for the sports team. By dragging an icon 62 left or right, a user can modify their sentiment rating (currently indicated as “97” in FIG. 3). The real-time sentiment index for this sports team is also displayed as an icon 64 on the graphical slider 50 (currently indicated as “50” in FIG. 3). The graphical input mechanism 50 further includes a user comment field 66 for the submission of textual commentary on the sports team, its real-time sentiment index, or the users' sentiment rating.

The display area 52 is configured to display a graph 68 of the historic values of the real-time sentiment index for this sports team over a past time period (currently indicated as Aug. 1, 2010, to Aug. 31, 2010, in FIG. 3). The time period of the graph 68 may be modified using one or both of the date selection menus 70. As can be seen in FIG. 3, the graph 68 allows for a visual comparison between the historic values of the real-time sentiment index for this sports team and the historic sentiment ratings of the individual user. Using the competitor selection menu 72, the user may alternatively create a visual comparison between the historic values of the real-time sentiment index for this sports team and the historic values of the real-time sentiment index for a competitive sports team. As described above with regard to steps 38-42 of method 30, the server 12 may perform these comparisons and transmit the information to a computing device 18, 20, which may then display this information on the interface 24. The interface 24 may also display one or more news items and/or one or more user comments as icons 74 on the graph 68 to indicate the date and time of such news items and/or user comments relative to the historic values of the real-time sentiment index.

The interface 24 may also include a display area 54 configured to display one or more news items relating to the sports team. In some embodiments, the display area 54 may alternatively, or additionally, be configured to display one or more user comments relating to the sports team. The display area 56 may be configured to display an advertisement having content relating to the sentiment ratings provided by the user, as described above. The display areas 58 may be configured to display user account information. It will be appreciated that the interface 24 of FIG. 3 is illustrative in nature and that, in other embodiments of the interface 24, some or all of the display areas 52-58 may be rearranged, resized, or even absent.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure and the appended claims are desired to be protected.

1. A method comprising:
receiving, over a communications network, user-initiated quantitative sentiment ratings regarding an entity; and
calculating a real-time sentiment index for the entity using the received sentiment ratings.

2. The method of claim 1, wherein the entity is a sports team or an individual athlete.

3. The method of claim 1, wherein the entity is user-defined.

4. The method of claim 1, wherein calculating the real-time sentiment index comprises updating a perpetual sentiment index.

5. The method of claim 1, wherein calculating the real-time sentiment index comprises recalculating the real-time sentiment index at least once every minute when new sentiment ratings have been received.

6. The method of claim 1, wherein receiving user-initiated quantitative sentiment ratings comprises receiving user-initiated quantitative sentiment ratings from a plurality of users.

7. The method of claim 6, wherein calculating the real-time sentiment index comprises calculating a real-time mean or a real-time median of the sentiment ratings received from the plurality of users.

8. The method of claim 7, wherein the plurality of users includes all users that are providing sentiment ratings regarding the entity.

9. The method of claim 7, wherein the plurality of users includes a user-defined subset of all users that are providing sentiment ratings regarding the entity.

10. The method of claim 1, further comprising transmitting the real-time sentiment index over the communications network for display to a user.

11. The method of claim 10, further comprising storing the received sentiment ratings in a database of historic sentiment ratings.

12. The method of claim 11, further comprising calculating historic values of the real-time sentiment index over a past time period using the historic sentiment ratings.

13. The method of claim 12, further comprising transmitting the historic values of the real-time sentiment index over the communications network for display to a user.

14. The method of claim 13, further comprising transmitting one or more news items regarding the entity that were generated during the past time period over the communications network for display along with the historic values of the real-time sentiment index.

15. The method of claim 13, further comprising receiving one or more user comments regarding the entity, the one or more user comments being generated contemporaneously with the user-initiated quantitative sentiment ratings.

16. The method of claim 15, further comprising transmitting one or more user comments regarding the entity that were generated during the past time period over the communications network for display along with the historic values of the real-time sentiment index.

17. The method of claim 13, further comprising transmitting the historic sentiment ratings that were generated by a particular user during the past time period over the communications network for display along with the historic values of the real-time sentiment index.

18. The method of claim 1, further comprising transmitting a comparison of the real-time quantitative sentiment index for the entity with a real-time sentiment index for a competitive entity over the communications network for display to a user.

19. The method of claim 1, further comprising transmitting an advertisement over the communications network for display to a user, the advertisement having content related to the entity for which sentiment ratings are received.

20. One or more non-transitory, machine-readable media comprising a plurality of instructions that, when executed, result in a processor:
receiving, over a communications network, user-initiated quantitative sentiment ratings regarding an entity; and
calculating a real-time sentiment index for the entity using the received sentiment ratings.

21. The one or more non-transitory, machine-readable media of claim 20, wherein the entity is a sports team or an individual athlete.

22. The one or more non-transitory, machine-readable media of claim 20, wherein the entity is user-defined.

23. The one or more non-transitory, machine-readable media of claim 20, wherein calculating the real-time sentiment index comprises updating a perpetual sentiment index.

24. The one or more non-transitory, machine-readable media of claim 20, wherein calculating the real-time sentiment index comprises recalculating the real-time sentiment index at least once every minute when new sentiment ratings have been received.

25. The one or more non-transitory, machine-readable media of claim 20, wherein receiving user-initiated quantitative sentiment ratings comprises receiving user-initiated quantitative sentiment ratings from a plurality of users.

26. The one or more non-transitory, machine-readable media of claim 25, wherein calculating the real-time sentiment index comprises calculating a real-time mean or a real-time median of the sentiment ratings received from the plurality of users.

27. The one or more non-transitory, machine-readable media of claim 26, wherein the plurality of users includes all users that are providing sentiment ratings regarding the entity.

28. The one or more non-transitory, machine-readable media of claim 26, wherein the plurality of users includes a user-defined subset of all users that are providing sentiment ratings regarding the entity.

29. The one or more non-transitory, machine-readable media of claim 20, wherein the plurality of instructions, when executed, further result in the processor transmitting the real-time sentiment index over the communications network for display to a user.

30. The one or more non-transitory, machine-readable media of claim 29, wherein the plurality of instructions, when executed, further result in the processor storing the received sentiment ratings in a database of historic sentiment ratings.

31. The one or more non-transitory, machine-readable media of claim 30, wherein the plurality of instructions, when executed, further result in the processor calculating historic values of the real-time sentiment index over a past time period using the historic sentiment ratings.

32. The one or more non-transitory, machine-readable media of claim 31, wherein the plurality of instructions, when executed, further result in the processor transmitting the historic values of the real-time sentiment index over the communications network for display to a user.

33. The one or more non-transitory, machine-readable media of claim 32, wherein the plurality of instructions, when executed, further result in the processor transmitting one or more news items regarding the entity that were generated during the past time period over the communications network for display along with the historic values of the real-time sentiment index.

34. The one or more non-transitory, machine-readable media of claim 32, wherein the plurality of instructions, when executed, further result in the processor receiving one or more user comments regarding the entity, the one or more user comments being generated contemporaneously with the user-initiated quantitative sentiment ratings.

35. The one or more non-transitory, machine-readable media of claim 34, wherein the plurality of instructions, when executed, further result in the processor transmitting one or more user comments regarding the entity that were generated during the past time period over the communications network for display along with the historic values of the real-time sentiment index.

36. The one or more non-transitory, machine-readable media of claim 32, wherein the plurality of instructions, when executed, further result in the processor transmitting the historic sentiment ratings that were generated by a particular user during the past time period over the communications network for display along with the historic values of the real-time sentiment index.

37. The one or more non-transitory, machine-readable media of claim 20, wherein the plurality of instructions, when executed, further result in the processor transmitting a comparison of the real-time quantitative sentiment index for the entity with a real-time sentiment index for one or more competitive entities over the communications network for display to a user.

38. The one or more non-transitory, machine-readable media of claim 20, wherein the plurality of instructions, when executed, further result in the processor transmitting an advertisement over the communications network for display to a user, the advertisement having content related to the entity for which sentiment ratings are received.

39. Apparatus comprising:
a plurality of computing devices each including an interface configured for the input of user-initiated quantitative sentiment ratings; and
a server which is configured to: (i) receive sentiment ratings from the plurality of computing devices, (ii) determine a first subset of the received sentiment ratings that relate to a first entity, and (iii) calculate a first real-time sentiment index for the first entity using sentiment ratings from the first subset.

40. The apparatus of claim 39, wherein the server is configured to recalculate the first real-time sentiment index at least once every minute when new sentiment ratings that relate to the first entity have been received.

41. The apparatus of claim 39, wherein the interface of each of the plurality of computing devices comprises a graphical slider that a user may set to a number indicating the user's present sentiment toward an entity.

42. The apparatus of claim 39, wherein each of the plurality of computing devices comprises a dedicated application that controls the interface and transmits input sentiment ratings to the server.

43. The apparatus of claim 39, wherein the server is configured to receive sentiment ratings from the plurality of computing devices via at least one of electronic mail and SMS messages.

44. The apparatus of claim 39, wherein:
the server is further configured to transmit the first real-time sentiment index to the plurality of computing devices; and
the interface of each of the plurality of computing devices is further configured to display the first real-time sentiment index.

45. The apparatus of claim 44, wherein the server is further configured to store the received sentiment ratings in a database of historic sentiment ratings.

46. The apparatus of claim 45, wherein the server is further configured to calculate historic values of the first real-time sentiment index over a past time period using historic sentiment ratings from the first subset.

47. The apparatus of claim 46, wherein:
the server is further configured to transmit the historic values of the first real-time sentiment index to the plurality of computing devices; and
the interface of each of the plurality of computing devices is further configured to display the historic values of first real-time sentiment index.

48. The apparatus of claim 47, wherein the interface of each of the plurality of computing devices is configured to display a graph of the historic values of first real-time sentiment index over the past time period.

49. The apparatus of claim 47, wherein:
the server is further configured to transmit one or more news items relating to the first entity that were generated during the past time period to the plurality of computing devices; and
the interface of each of the plurality of computing devices is further configured to display the one or more news items along with historic values of first real-time sentiment index.

50. The apparatus of claim 47, wherein the interface of each of the plurality of computing devices is further configured for the input of user comments contemporaneously with the input of user-initiated quantitative sentiment ratings.

51. The apparatus of claim 50, wherein:
the server is further configured to transmit one or more user comments relating to the first entity that were input during the past time period to the plurality of computing devices; and
the interface of each of the plurality of computing devices is further configured to display the one or more user comments along with historic values of first real-time sentiment index.

52. The apparatus of claim 39, wherein the server is further configured to transmit an advertisement having content related to the first entity to each of the plurality of computing devices that transmits sentiment ratings relating to the first entity.

53. The apparatus of claim 39, wherein the server is further configured to (i) determine a second subset of the received sentiment ratings that relate to a second entity and (ii) calculate a second real-time sentiment index for the second entity using the second subset of the received sentiment ratings.

54. The apparatus of claim 53, wherein the first and second entities are each sports teams or individual athletes.

55. The apparatus of claim 53, wherein the first and second entities each belong to a user-defined category.

56. The apparatus of claim 53, wherein:
the server is further configured to transmit a comparison of the first real-time sentiment index and the second real-time sentiment index to the plurality of computing devices; and
the interface of each of the plurality of computing devices is further configured to display the comparison.

57. The apparatus of claim 56, wherein the server is further configured to store the received sentiment ratings in a database of historic sentiment ratings.

58. The apparatus of claim 57, wherein the server is further configured to:
calculate historic values of the first real-time sentiment index over a past time period using historic sentiment ratings from the first subset; and
calculate historic values of the second real-time sentiment index over the past time period using historic sentiment ratings from the second subset.

59. The apparatus of claim 58, wherein:
the server is further configured to transmit a comparison of the historic values of the first real-time sentiment index and the historic values of the first real-time sentiment index to the plurality of computing devices; and
the interface of each of the plurality of computing devices is further configured to display the comparison.

60. The apparatus of claim 59, wherein the comparison comprises a graph illustrating the historic values of the first real-time sentiment index and the historic values of the first real-time sentiment index over the past time period.
